(19) United States
(12) Patent Application Publication
(10) Pub. No.: US 2010/0147849 A1
(43) Pub. Date: Jun. 17, 2010

(54) Cover for septic pen

(76) Inventor: Damien Ross, St-Mathieu de Beloeil (CA)

Correspondence Address: Eric Fincham, 316 Knowlton Road, Lac Brome, QC, J0E 1V0, CA

(21) Appl. No.: 12/592,707

(22) Filed: Nov. 30, 2009

(30) Foreign Application Priority Data
Dec. 1, 2008 (CA) 2,645,528

(51) Int. Cl. B65D 51/00; A01K 29/00

(52) U.S. Cl. 220/212; 220/200; 119/161

(57) ABSTRACT

A cover arrangement for a manure pit comprising a support arch extending over the manure pit, a cover formed of sheet material which is secured with an upper portion of a wall extending about the manure pit, a cable extending between opposed sides of the wall, the cable passing over the arch and being secured thereto, a block mounted to another side of the arch, a further cable secured to the cover and to the block and a winding arrangement for raising and lowering the cover.

### FIELD OF THE INVENTION

The present invention relates to a cover structure and more particularly, it relates to a cover structure suitable for use with septic pens such as may be used for pig manure.

### BACKGROUND OF THE INVENTION

The storage and disposal of liquid pig manure has always presented a problem to the agriculture industry. Since the pig manure ordinarily cannot be used as fertilizer without further treatment, it is usually stored by the farmer in a manure or septic pit. Frequently, the manure is to be transported to a central facility where it is treated before disposal of the same. During the storage, the liquid manure can be problematic due to its odours.

Apart from direct application to fields as a fertilizer, liquid manure is traditionally subjected to various means of handling and treatment. Most are based on separation processes using various mechanical, physical, chemical and other methods. However, most separation processes have a very low efficiency and there is also the cost of reagents needed for chemical coagulation and flocculation.

In view of the above, most liquid manure is stored in manure pits formed of a concrete material. They are then transferred to a central processing centre. However, the liquid manure must still be stored for a period of time.

### SUMMARY OF THE INVENTION

It is an object of the present invention to provide a system for permitting storage for liquid manure while obviating the problem of odours and associated problems.

According to one aspect of the present invention there is provided a cover arrangement for a manure pit having a wall defining the pit, the cover arrangement comprising a support arch extending over the manure pit, a cover formed of sheet material covering the manure pit, the sheet material being secured to an upper portion of the wall, a cable extending between opposed sides of the wall, the cable passing over the arch and being secured thereto, a block mounted to an underside of the arch, at least one cable secured at one end thereof to a central area of the cover, the other end of the cable being secured to the block, and means for winding the at least one cable for raising and lowering the cover.

The wall defining the manure pit can be of any configuration desired, such as rectangular, oblong, etc. However, traditionally such pits are designed to have a generally circular wall.

A support arch extends over the manure pit and may be attached or supported by the ground adjacent the manure pit or alternatively, the arch may be seated on the top wall of the manure pit and extend diametrically thereover.

The cover is formed of a suitable sheet material, preferably one which is resistant to the various chemicals in the pig manure. Numerous plastics would be suitable for use as a cover including a reinforced type of plastic sheet.

Preferably, a pump and a discharge conduit are provided for placement on top of the cover for removal of any excess water such as rain water. The manure pit may also have an outlet in the wall for discharge of the manure by a suitable pump when it is desired to transfer the same to a vehicle for shipment to a central processing facility. Alternatively, the conduit may access the pig manure by lifting off a portion of the cover.

The system utilizes a series of cables for supporting the cover and for lifting of the same. Such cables are known in the art.

### BRIEF DESCRIPTION OF THE DRAWINGS

Having thus generally described the invention, reference will be made to the accompanying drawings illustrating an embodiment of the invention wherein:

FIG. 1 is a perspective view of a manure pit and cover structure associated therewith;

FIG. 2 is a perspective view of a side anchoring device;

FIG. 3 is a cross-sectional view thereof;

FIG. 4 is a cross-sectional view of the arrangement at the upper side of the manure pit wall;

FIG. 5 is a side-elevational view of the arch structure;

FIG. 6 is a perspective view of the centre support; and

FIG. 7 is a perspective view illustrating a partial opening of one portion of the cover.

### DETAILED DESCRIPTION OF THE INVENTION

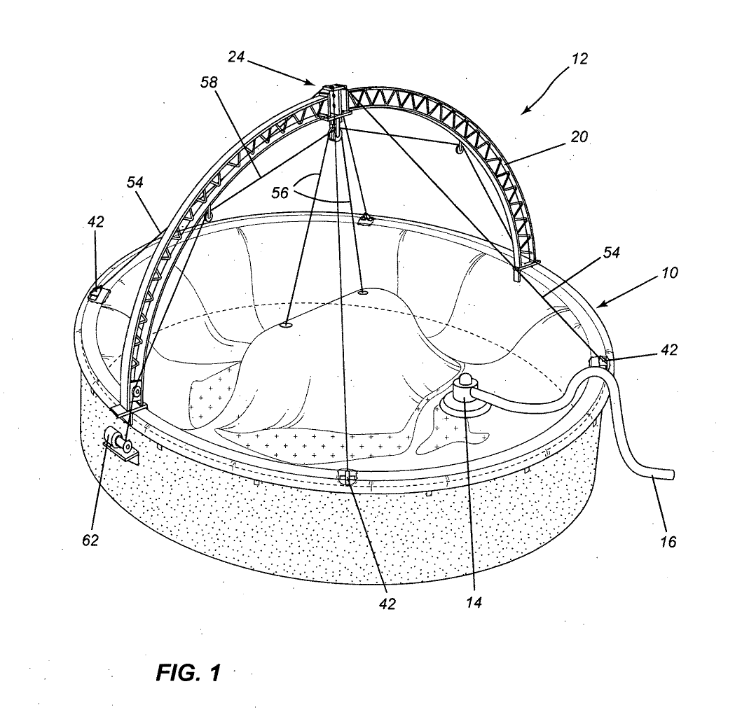

Referring to the drawings in greater detail and by reference characters thereto, there is illustrated in FIG. 1 a manure pit generally designated by reference number 10 which has a cover structure 12 associated therewith.

Cover structure 10 includes a cover or tarpaulin 18 which has an outlet 14 therein to permit pumping of any water on the cover through a conduit 16.

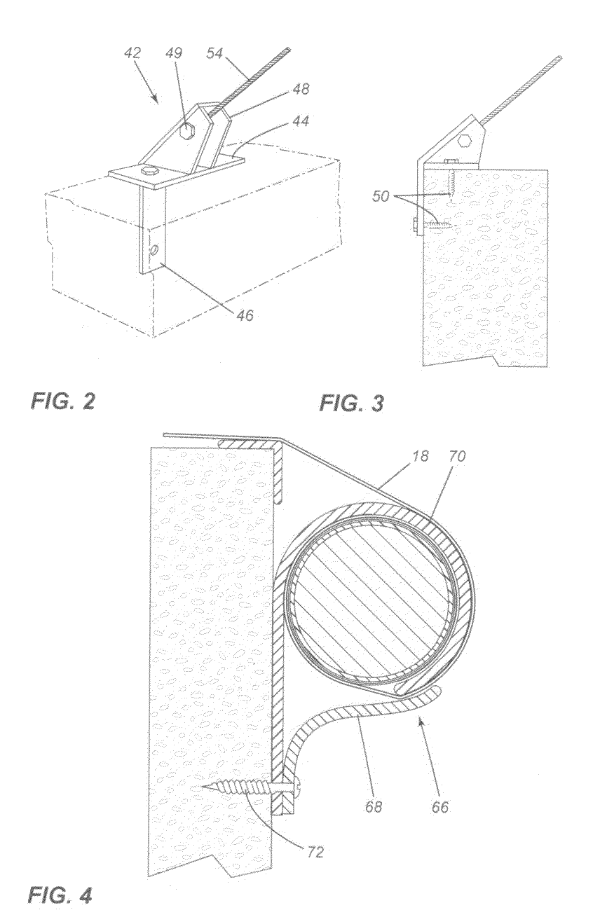

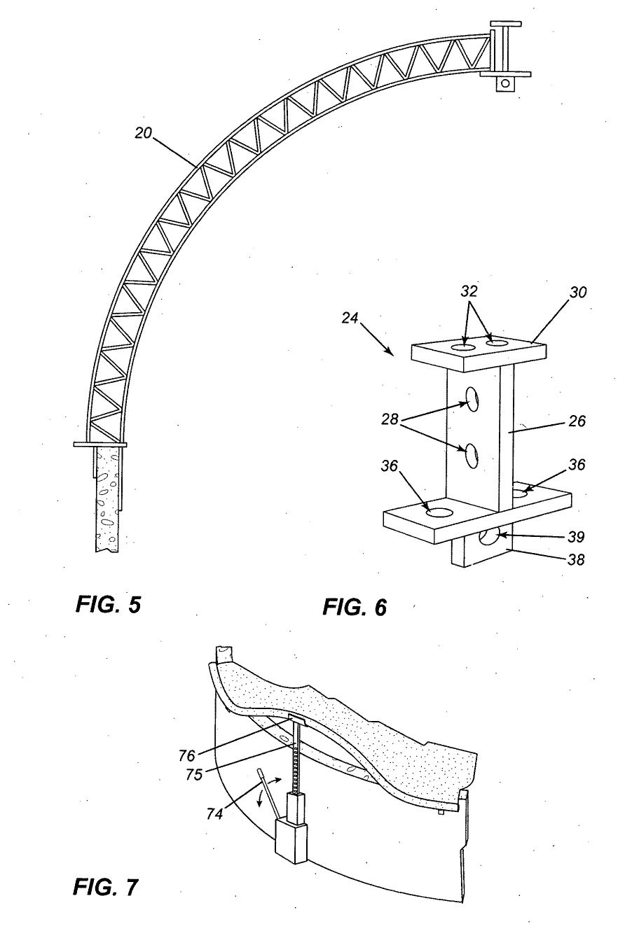

The cover structure also includes an arch generally designated by reference number 20. Arch 20 is connected on both sides to the manure pit side 22. As may be best seen in FIG. 6 there is provided a centre support 24 which has a vertical centre wall 26 with a pair of apertures 28 therein. Centre support 24 also includes a top wall 30 with a pair of apertures 32 and a bottom wall 34 with a pair of apertures 36 being located therein. A bottom flange 38 extends downwardly and has an aperture 39 formed therein. A plurality of cables securing members 40 are spaced around the upper side wall of manure pit 10. As may be seen in greater detail in FIGS. 2 and 3, each cable securing member 42 has a base plate 44 and a vertically extending element 46. Mounted on base plate 44 is an inverted U-shaped element 48 having a rod 49 extending therethrough to which a cable 54 may be secured. Screws 50 are utilized to secure cable securing member 42 to the wall of manure pit 10.

A plurality of cables 54 extend from centre support 24 to cable securing members 42. A cable 56 also extends between centre support 24 and cover 18. A central cable 58 is utilized to raise or lower cover 18 through cables 56 by means of a reel 62 turned by operator 60.

As may be seen in FIG. 4, a clamp structure 66 has a lower portion 68 and an upper portion 70, each of which is retained in position by means of a screw 72. Clamps 66 which extend about the periphery of manure pit 10 are utilized to maintain cover 18 in position. However, when desired, a lever 74 may be moved to drive a member 75 upwardly and clamp 76 moves cover 18 to provide access to the interior of the manure pit for cleaning purposes or the like.

It will be understood that the above described embodiments are for purposes of illustration only and that changes and modifications may be made thereto without departing from the spirit and scope of the invention.

I claim:

1. A cover arrangement for a manure pit having a wall defining said pit, the cover arrangement comprising:
a support arch extending over said manure pit;
a cover formed of sheet material covering said manure pit, said sheet material being secured to an upper portion of said wall;
a cable extending between opposed sides of said wall, said cable passing over said arch and being secured thereto;
a block mounted to an underside of said arch;
at least one cable secured at one end thereof to a central area of said cover, the other end of said cable being secured to said block; and
means for winding said at least one cable for raising and lowering said cover.

2. The cover arrangement of claim 1 wherein said wall defining said manure pit is circular.

3. The cover arrangement of claim 1 further including means for raising a portion of said cover adjacent said wall.

4. The cover arrangement of claim 3 wherein said means comprises a vertical member having a top portion thereof secured to said cover, and a lever secured to a lower portion of said member, said lever being operative to raise said member and said cover.

5. The cover arrangement of claim 1 further including a pump located on an upper surface of said cover, said pump being connected to a discharge conduit.
